(19) United States
(12) Patent Application Publication
(10) Pub. No.: US 2015/0367279 A1
(43) Pub. Date: Dec. 24, 2015

(54) HOLLOW FIBER MEMBRANE AND HOLLOW FIBER MEMBRANE MODULE COMPRISING THE SAME

(71) Applicant: KOLON INDUSTRIES, INC., Gwacheon-si, Gyeonggi-do (KR)

(72) Inventors: Kyoung Ju KIM, Yongin-si (KR); Young Seok OH, Yongin-si (KR); Jin Hyung LEE, Yongin-si (KR); Moo Seok LEE, Seoul (KR)

(73) Assignee: KOLON INDUSTRIES, INC., Gwacheon-si (KR)

(21) Appl. No.: 14/765,372

(22) PCT Filed: Feb. 4, 2014
(86) PCT No.: PCT/KR2014/000943

§ 371 Date: Aug. 3, 2015

(30) Foreign Application Priority Data
Feb. 4, 2013 (KR) 10-2013-0012544

(51) Int. Cl. B01D 53/22; H01M 8/04; B01D 63/02

(52) U.S. Cl. CPC B01D 53/228; B01D 63/02; H01M 8/04149; B01D 2053/224

(57) ABSTRACT

The present invention relates to a hollow fiber membrane and a hollow fiber membrane module including the same, and the hollow fiber membrane is characterized in that any one selected from the group consisting of the inner diameter and the outer diameter of the hollow fiber membrane and a combination thereof is changed. The hollow fiber membrane induces turbulence of a fluid flow at the inside and outside of the hollow fiber membrane and, thus, improves flow uniformity, thereby maximizing performance of the hollow fiber membrane module including the hollow fiber membrane.

### TECHNICAL FIELD

The present invention relates to a hollow fiber membrane and a hollow fiber membrane module including the same, and, more particularly, to a hollow fiber membrane, which may induce turbulence of a fluid flow at the inside and outside of the hollow fiber membrane and, thus, improve flow uniformity so as to maximize performance of a hollow fiber membrane module including the hollow fiber membrane, and a hollow fiber membrane module having the hollow fiber membrane.

The hollow fiber membrane may be applied to a hollow fiber membrane module, such as a gas separation module, a humidification module or a water treatment module.

### BACKGROUND ART

In general, fuel cells are power generation type cells which generate electricity by combining hydrogen with oxygen. Fuel cells may continuously produce electricity as long as hydrogen and oxygen are supplied, differently from general chemical cells, such as batteries or storage batteries, and have no thermal loss, thus having efficiency that is 2 times that of internal combustion engines. Further, fuel cells convert chemical energy, generated by combination of hydrogen and oxygen, directly into electric energy, thus emitting a small amount of pollutants. Therefore, fuel cells may be eco-friendly and reduce worry about exhaustion of resources due to increase in energy consumption. Such fuel cells may be classified into a polymer electrolyte membrane fuel cell (PEMFC), a phosphoric acid fuel cell (PAFC), a molten carbonate fuel cell (MCFC), a solid oxide fuel cell (SOFC), an alkaline fuel cell (AFC) and the like according to kinds of electrolytes to be used. These respective fuel cells are basically operated by the same principle but are different in terms of kinds of used fuels, operating temperatures, catalysts, electrolytes and the like. Thereamong, since a PEMFC is operated at a low temperature, as compared to other fuel cells, and has a high power density and may thus be minimized, it is known that the PEMFC is the most useful in transportation systems as well as small mounting-type power generation equipments.

One of the most important factors to improve performance of the PEMFC is to maintain a water content by supplying moisture of a designated amount or more to a polymer electrolyte membrane or proton exchange membrane (PEM) of a membrane electrode assembly (MEA). The reason for this is that, if the polymer electrolyte membrane is dry, power generation efficiency is rapidly lowered. In order to humidify the polymer electrolyte membrane, there are 1) a bubbler humidification method in which a pressure resistant container is filled with water and moisture is supplied by causing a target gas to pass through a diffuser, 2) a direct injection method in which an amount of moisture required for reaction of a fuel cell is calculated and moisture is supplied directly to a gas flow pipe through a solenoid valve based on the calculated amount of moisture, 3) a humidification membrane method in which moisture is supplied to a fluidized bed of gas using a polymer separation membrane, and the like. Among these methods, the humidification membrane method, in which a polymer electrolyte membrane is humidified by providing vapor to gas supplied to the polymer electrolyte membrane using a membrane selectively transmitting only vapor included in exhaust gas, may reduce the weight and size of a humidifier, thus being advantageous.

If a module is formed using selective permeable membranes used in the humidification membrane method, hollow fiber membranes having a large transmission area per unit volume may be used. That is, if a humidifier is manufactured using hollow fiber membranes, since high integration of the hollow fiber membranes having a large contact surface area may be achieved, a fuel cell may be sufficiently humidified at a small capacity of the hollow fiber membranes using a low cost material, and moisture and heat may be recovered from unreacted gas of a high temperature exhausted from the fuel cell and reused through the humidifier.

However, conventional hollow fiber membranes are manufactured under designated conditions through a single nozzle and, thus, have a rectilinear shape having uniform outer and inner diameters. If the hollow fiber membranes having such a shape are mounted in a module for separation of gas or separation of liquid, flow resistance is minimized and, thus, it is difficult to make a uniform flow due to formation of turbulence and maximization of performance of a product is hindered. In order to make up for such drawbacks, a member or a baffle to provide flow resistance may be added but addition of such a member or a baffle causes an increase in manufacturing costs and a difficulty in design.

### PRIOR ART DOCUMENTS

Korean Patent Publication No. 10-2009-0013304 (Publication Date: Feb. 5, 2009)

Korean Patent Publication No. 10-2009-0057773 (Publication Date: Jun. 8, 2009)

Korean Patent Publication No. 10-2009-0128005 (Publication Date: Dec. 15, 2009)

Korean Patent Publication No. 10-2010-0108092 (Publication Date: Oct. 6, 2010)

Korean Patent Publication No. 10-2010-0131631 (Publication Date: Dec. 16, 2010)

Korean Patent Publication No. 10-2011-0001022 (Publication Date: Jan. 6, 2011)

Korean Patent Publication No. 10-2011-0006122 (Publication Date: Jan. 20, 2011)

Korean Patent Publication No. 10-2011-0006128 (Publication Date: Jan. 20, 2011)

Korean Patent Publication No. 10-2011-0021217 (Publication Date: Mar. 4, 2011)

Korean Patent Publication No. 10-2011-0026696 (Publication Date: Mar. 16, 2011)

Korean Patent Publication No. 10-2011-0063366 (Publication Date: Jun. 10, 2011)

### DISCLOSURE

### Technical Problem

Therefore, the present invention has been made in view of the above problems, and it is an object of the present invention to provide a hollow fiber membrane which may induce turbulence of a fluid flow at the inside and outside of the hollow fiber membrane and thus improve flow uniformity so as to maximize performance of a hollow fiber membrane module including the hollow fiber membrane.

It is another object of the present invention to provide a hollow fiber membrane module including the hollow fiber membrane.

### Technical Solution

In accordance with an aspect of the present invention, the above and other objects can be accomplished by the provision of a hollow fiber membrane configured such that any one selected from the group consisting of the inner diameter of the hollow fiber membrane, the outer diameter of the hollow fiber membrane, and a combination thereof is changed in the length direction.

Change of the any one, selected from the group consisting of the inner diameter of the hollow fiber membrane, the outer diameter of the hollow fiber membrane, and a combination thereof, in the length direction may have a cycle.

Change of the any one, selected from the group consisting of the inner diameter of the hollow fiber membrane, the outer diameter of the hollow fiber membrane, and a combination thereof, in the length direction may be repeated in a cycle having a length being 2 to 40 times the mean outer diameter of the hollow fiber membrane.

The inner diameter of the hollow fiber membrane may be changed within ±40% of the mean inner diameter of the hollow fiber membrane.

The outer diameter of the hollow fiber membrane may be changed within ±20% of the mean outer diameter of the hollow fiber membrane.

The outer diameter of the hollow fiber membrane may be 0.5 to 1.8 mm, and the inner diameter of the hollow fiber membrane may be 0.2 to 1.5 mm.

The hollow fiber membrane may have the maximum value of the inner diameter at a position having the maximum value of the outer diameter and have the minimum value of the inner diameter at a position having the minimum value of the outer diameter.

The hollow fiber membrane may have the maximum thickness at the position having the maximum value of the outer diameter and have the minimum thickness at the position having the minimum value of the outer diameter.

The inner diameter of the hollow fiber membrane may be changed in the length direction and the outer diameter of the hollow fiber membrane may be constant.

The outer diameter of the hollow fiber membrane may be changed in the length direction and the inner diameter of the hollow fiber membrane may be constant.

In accordance with another aspect of the present invention, there is provided a hollow fiber membrane module including a housing unit, and a hollow fiber membrane unit installed within the housing unit and including a plurality of hollow fiber membranes, wherein at least one of the hollow fiber membranes is configured such that any one selected from the group consisting of the inner diameter of the hollow fiber membrane, the outer diameter of the hollow fiber membrane, and a combination thereof is changed in the length direction.

Both ends of the housing unit may be open and an injection hole and a discharge hole may be formed on the outer surface of the housing unit.

The hollow fiber membrane module may further include potting units configured to fix both ends of the hollow fiber membranes to the housing unit and contacting both ends of the housing units so as to be hermetically sealed.

The hollow fiber membrane module may further include covers combined with both ends of the housing unit and including gas entrances.

The hollow fiber membrane module may be any one selected from the group consisting of a gas separation module, a humidification module and a water treatment module.

### Advantageous Effects

A hollow fiber membrane in accordance with the present invention may induce turbulence of a fluid flow at the inside and outside of the hollow fiber membrane and thus improve flow uniformity, thereby maximizing performance of a hollow fiber membrane module including the hollow fiber membrane.

### DESCRIPTION OF DRAWINGS

The above and other objects, features and other advantages of the present invention will be more clearly understood from the following detailed description taken in conjunction with the accompanying drawings, in which:

FIG. 1 is a partially exploded perspective view illustrating a hollow fiber membrane module including hollow fiber membranes in accordance with one embodiment of the present invention;

FIG. 2 is a partial longitudinal-sectional view of the hollow fiber membrane module of FIG. 1;

FIG. 3 is a longitudinal-sectional view of a conventional hollow fiber membrane;

FIG. 4 is a transversal-sectional view of FIG. 3, taken along line A-A′;

FIG. 5 is a longitudinal-sectional view of a hollow fiber membrane in accordance with one embodiment of the present invention;

FIG. 6 is a transversal-sectional view of FIG. 5, taken along line B-B′;

FIG. 7 is a transversal-sectional view of FIG. 5, taken along line A-A′;

FIG. 8 is a longitudinal-sectional view of a hollow fiber membrane in accordance with another embodiment of the present invention;

FIG. 9 is a transversal-sectional view of FIG. 8, taken along line B-B′;

FIG. 10 is a transversal-sectional view of FIG. 8, taken along line A-A;

FIG. 11 is a longitudinal-sectional view of a hollow fiber membrane in accordance with yet another embodiment of the present invention;

FIG. 12 is a transversal-sectional view of FIG. 11, taken along line A-A′; and

FIG. 13 is a transversal-sectional view of FIG. 11, taken along line B-B′.

### BEST MODE

Now, preferred embodiments of the present invention will be described in detail with reference to the annexed drawings. However, the present invention may be implemented to have various different types and is not limited to the embodiments of the present invention which will be described below.

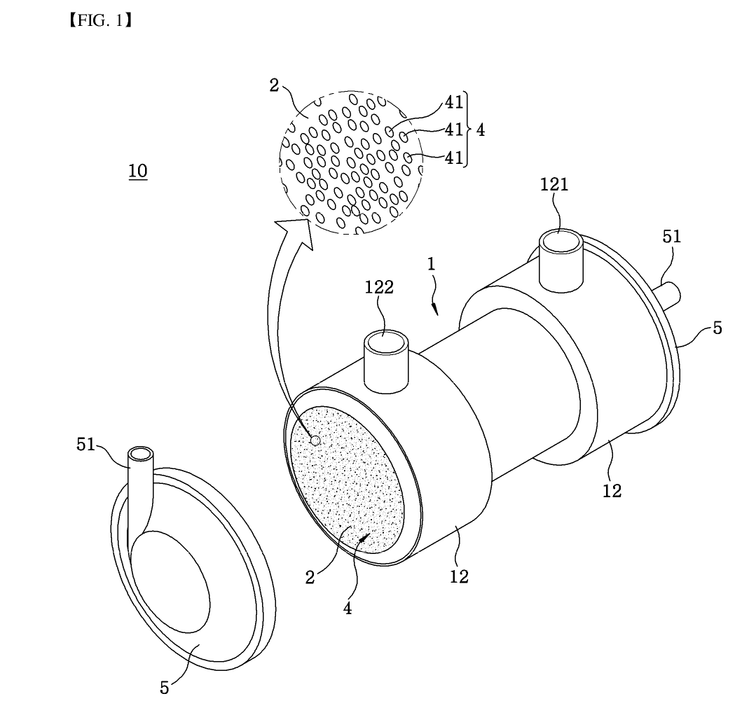

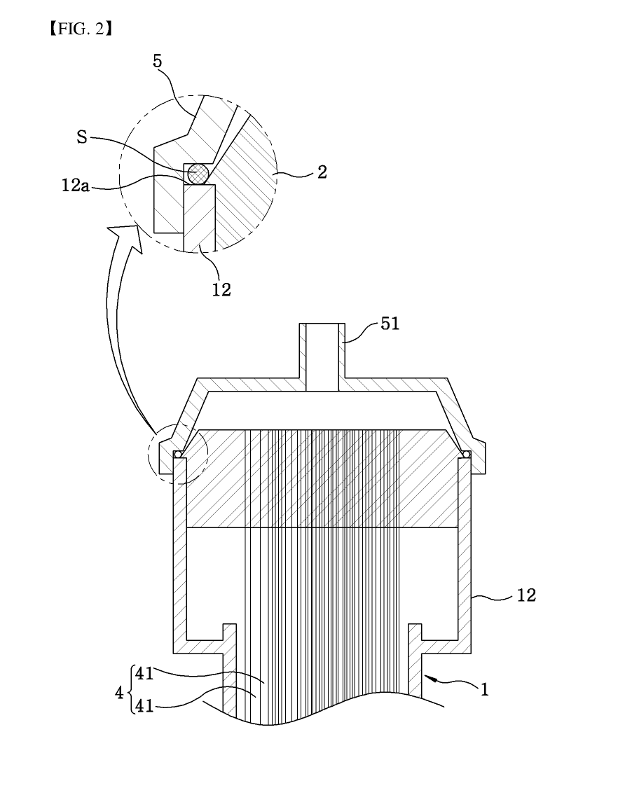

FIG. 1 is a partially exploded perspective view illustrating a hollow fiber membrane module having a hollow fiber membrane in accordance with one embodiment of the present invention and FIG. 2 is a partial longitudinal-sectional view of the hollow fiber membrane module of FIG. 1. The hollow fiber membrane module shown in FIGS. 1 and 2 is one embodiment of a humidification module. However, the hollow fiber membrane module is not limited to the humidification module and may be a gas separation module or a water treatment module.

With reference to FIGS. 1 and 2, the hollow fiber membrane module 10 includes a housing unit 1, a hollow fiber membrane unit 4, potting units 2 and covers 5.

The housing unit 1 and the covers 5 are members forming the external appearance of the hollow fiber membrane module 10. The housing unit 1 and the covers 5 may be formed of hard plastic, such as polycarbonate, or metal.

Both open ends of the housing unit 1 are buried under the potting units 2 and the potting units 2 are surrounded with circumferential parts 12 of the housing unit 1. An injection hole 121 to which humidifying gas is supplied is formed on the circumferential part 12 and a discharge hole 122 from which the humidifying gas having passed through the inside of the housing unit 1 is discharged is formed on the circumferential part 12 surrounding the other end of the housing unit 1.

The hollow fiber membrane unit 4 including a plurality of hollow fiber membranes 41 to selectively transmit moisture is installed within the housing unit 1. Here, the hollow fiber membranes 41 are formed of a well-known material and a detailed description thereof will thus be omitted.

The potting units 2 bind the hollow fiber membranes 41 at both ends of the hollow fiber membrane unit 4 and fill gaps between the hollow fiber membranes 41. The potting units 2 may contact the inner surfaces of both ends of the housing unit 1, thus hermetically sealing the housing unit 1. The potting units 2 are formed of a well-known material and a detailed description thereof will thus be omitted.

The potting units 2 are formed within both ends of the housing unit 1 and, thus, both ends of the hollow fiber membrane unit 4 are fixed to the housing unit 1. Thereby, both ends of the housing unit 1 are closed by the potting units 2 and a flow path through which humidifying gas passes is formed within the housing 1.

The covers 5 are combined with both ends of the housing unit 1. A gas entrance 51 is formed on each of the covers 5. Operating gas introduced into the gas entrance 51 of one cover 5 passes through the inner pipelines of the hollow fiber membranes 41, is humidified and then discharged from the gas entrance 51 of the other cover 5.

With reference to FIG. 2, the potting unit 2 may be formed so as to be inclined upwards from the nearly center of a tip 12a of the circumferential part 12 to the center of the housing 1 and the hollow fiber membranes 41 may pass through the potting unit 2 such that the pipelines of the hollow fiber membranes 41 are exposed to the outside at the end of the potting unit 2. A sealing member S may be provided at a part of the tip 12a of the circumferential part 12 which is not shielded by the potting unit 2 and the cover 5 may be combined with the housing unit 1 while pressurizing the sealing member S.

Any one selected from the group consisting of the inner diameter and outer diameter of the hollow fiber membranes 41 and a combination thereof is changed in the length direction. Hereinafter, the hollow fiber membranes 41 will be described in detail with reference to FIGS. 3 to 13.

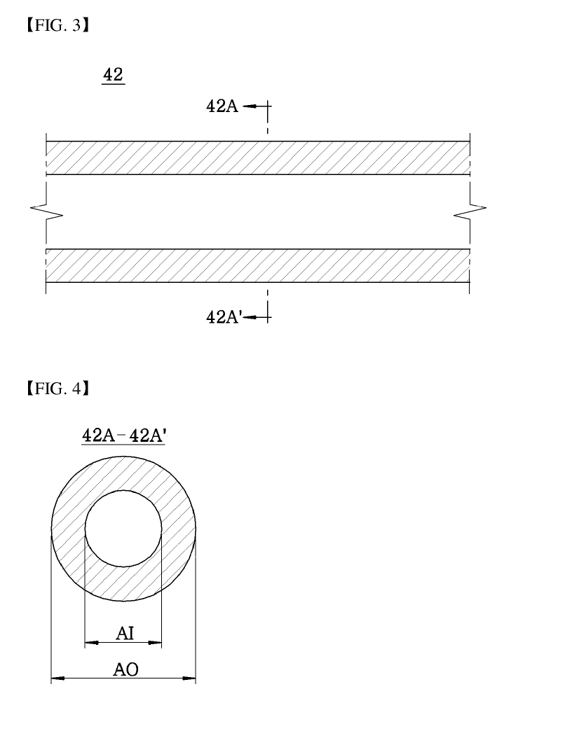

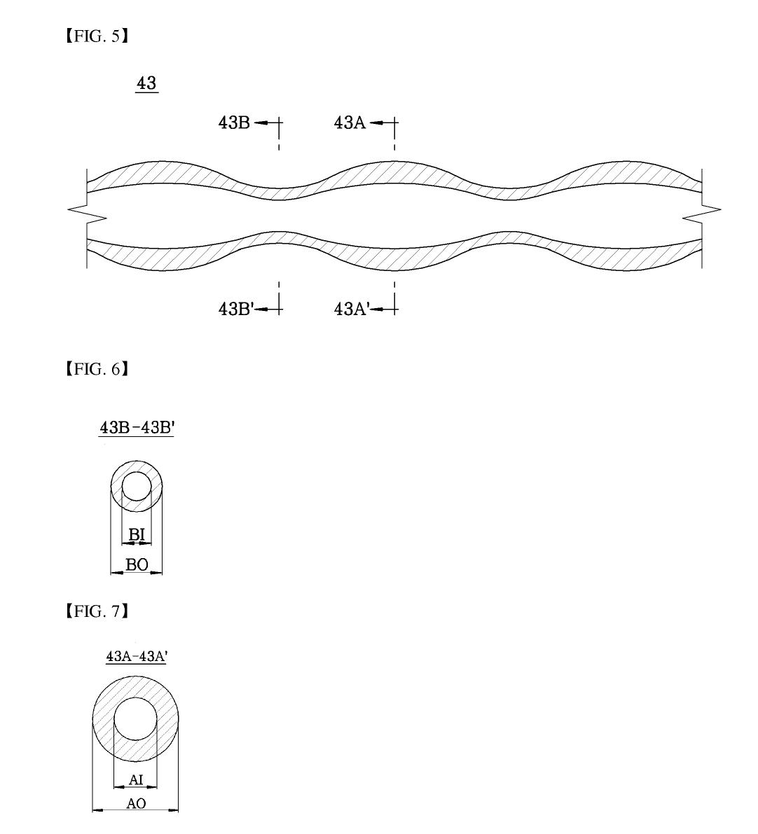

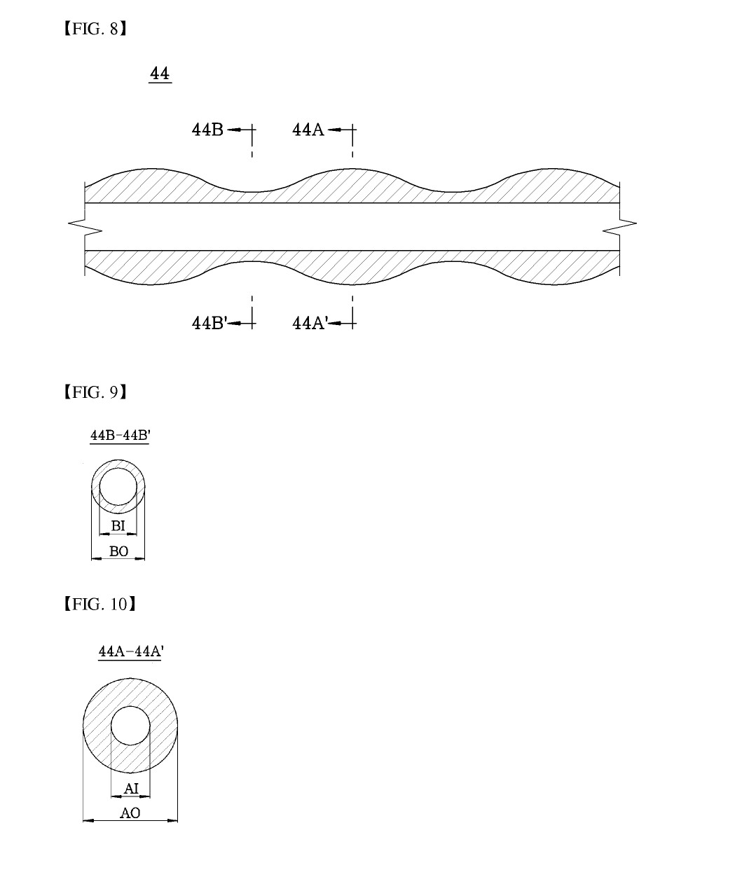

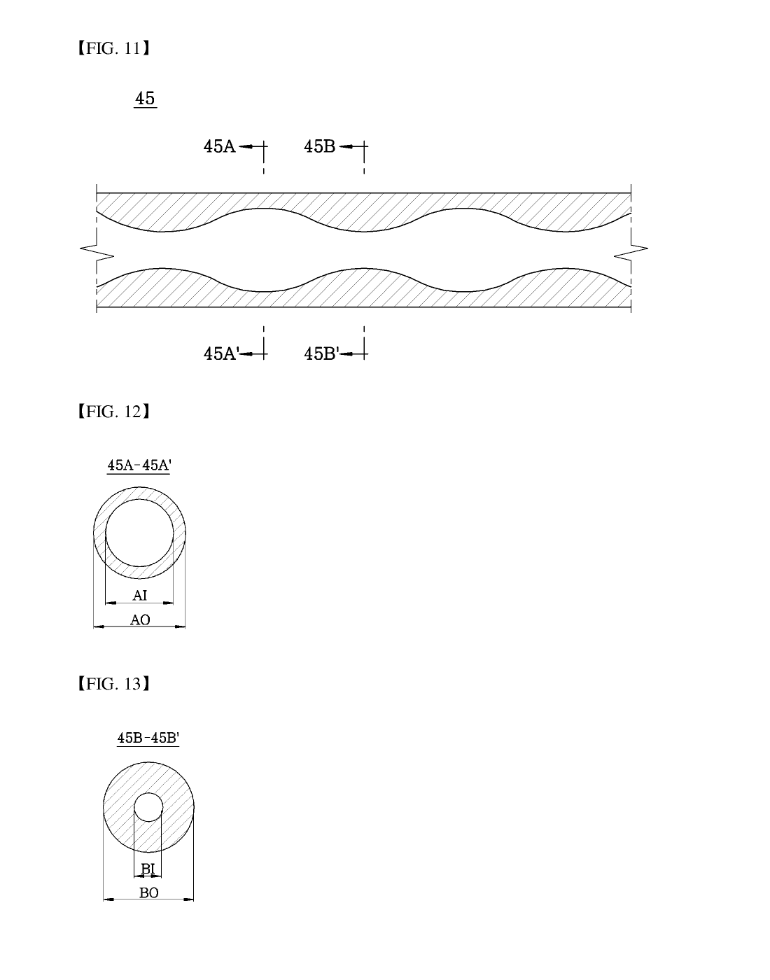

FIG. 3 is a longitudinal-sectional view of a conventional hollow fiber membrane, FIG. 4 is a transversal-sectional view of FIG. 3, taken along line A-A′, FIG. 5 is a longitudinal-sectional view of a hollow fiber membrane in accordance with one embodiment of the present invention, FIG. 6 is a transversal-sectional view of FIG. 5, taken along line B-B′, FIG. 7 is a transversal-sectional view of FIG. 5, taken along line A-A′, FIG. 8 is a longitudinal-sectional view of a hollow fiber membrane in accordance with another embodiment of the present invention, FIG. 9 is a transversal-sectional view of FIG. 8, taken along line B-B′, FIG. 10 is a transversal-sectional view of FIG. 8, taken along line A-A, FIG. 11 is a longitudinal-sectional view of a hollow fiber membrane in accordance with yet another embodiment of the present invention, FIG. 12 is a transversal-sectional view of FIG. 11, taken along line A-A′, and FIG. 13 is a transversal-sectional view of FIG. 11, taken along line B-B′.

With reference to FIGS. 3 and 4, a conventional hollow fiber membrane 42 has a constant inner diameter AI and a constant outer diameter AO in the length direction.

On the other hand, with reference to FIGS. 5 to 13, in the case of the hollow fiber membranes 43, 44 and 45 in accordance with embodiments of the present invention, any one selected from the group consisting of the inner diameters and outer diameters of the hollow fiber membranes 43, 44 and 45 and a combination thereof is changed in the length direction. The hollow fiber membranes 43, 44 and 45 may induce turbulence of fluid flows at the inside and outside of the hollow fiber membranes 43, 44 and 45 and thus improve flow uniformity, thereby maximizing performance of a hollow fiber membrane module 10 including the hollow fiber membranes 43, 44 and 45.

Change of any one, selected from the group consisting of the inner diameters and outer diameters of the hollow fiber membranes 43, 44 and 45 and a combination thereof, in the length direction may have a cycle and be carried out regularly. In more detail, change of any one, selected from the group consisting of the inner diameters and outer diameters of the hollow fiber membranes 43, 44 and 45 and a combination thereof, in the length direction may be repeated in a cycle having a length that are 2 to 40 times the mean outer diameters of the hollow fiber membranes 43, 44 and 45. If such a change cycle is less than 2 to 40 times the mean outer diameter, manufacture of the corresponding hollow fiber membrane may not easy and, if the change cycle exceeds 40 times the mean outer diameter, generation of turbulence due to provision of change of the outer diameter in the length direction may not be effective. The mean outer diameters of the hollow fiber membranes 43, 44 and 45 may be calculated as the arithmetic means of the maximum values and minimum values of the outer diameters of the hollow fiber membranes 43, 44 and 45 changed in the length direction during 1 cycle.

The inner diameters of the hollow fiber membranes 43, 44 and 45 may be changed within ±40% of the mean inner diameters of the hollow fiber membranes 43, 44 and 45 in the length direction and, preferably, be changed within ±20% of the mean inner diameters of the hollow fiber membranes 43, 44 and 45 in the length direction. If change of the inner diameters of the hollow fiber membranes 43, 44 and 45 exceeds ±40% of the mean inner diameters of the hollow fiber membranes 43, 44 and 45, it is difficult to stably manufacture the fiber membranes 43, 44 and 45. The mean inner diameters of the hollow fiber membranes 43, 44 and 45 may be calculated as the arithmetic means of the maximum values and minimum values of the inner diameters of the hollow fiber membranes 43, 44 and 45 changed in the length direction during 1 cycle.

The outer diameters of the hollow fiber membranes 43, 44 and 45 may be changed within ±40% of the mean outer diameters of the hollow fiber membranes 43, 44 and 45 in the length direction and, preferably, be changed within ±20% of the mean outer diameters of the hollow fiber membranes 43, 44 and 45 in the length direction. If change of the outer diameters of the hollow fiber membranes 43, 44 and 45 exceeds ±40% of the mean outer diameters of the hollow fiber membranes 43, 44 and 45, it is difficult to stably manufacture the fiber membranes 43, 44 and 45.

The outer diameters of the hollow fiber membranes 43, 44 and 45 may be 0.5 to 1.8 mm and the inner diameters of the hollow fiber membranes 43, 44 and 45 may be 0.2 to 1.5 mm. If the outer diameters of the hollow fiber membranes 43, 44 and 45 are less than 0.5 mm, it may be difficult to change the outer diameters of the hollow fiber membranes 43, 44 and 45 in the length direction and, if the outer diameters of the hollow fiber membranes 43, 44 and 45 exceed 1.8 mm, it may not be easy to maximize the areas of the hollow fiber membranes 43, 44 and 45 which may be applied to a limited housing. Further, if the inner diameters of the hollow fiber membranes 43, 44 and 45 are less than 0.2 mm, it may be difficult to change the inner diameters of the hollow fiber membranes 43, 44 and 45 in the length direction and, if the inner diameters of the hollow fiber membranes 43, 44 and 45 exceed 1.5 mm, it may not be easy to maximize the areas of the hollow fiber membranes 43, 44 and 45 which may be applied to the limited housing.

In more detail, with reference to FIGS. 5 to 7, the outer diameter AO of a part AA′ of the hollow fiber membrane 43, taken along line 43A-43A′, and the outer diameter AO of a part BB′ of the hollow fiber membrane 43, taken along line 43B-43B′ may be different. Further, the inner diameter AO of the part AA′ of the hollow fiber membrane 43, taken along line 43A-43A′, and the inner diameter AO of the part BB′ of the hollow fiber membrane 43, taken along line 43B-43B′ may be different.

Further, the part AA′ of the hollow fiber membrane 43, taken along line 43A-43A′, having the maximum value of the outer diameter AO may have the maximum value of the inner diameter AI, and the part BB′ of the hollow fiber membrane 43, taken along line 43B-43B′, having the minimum value of the outer diameter AO may have the minimum value of the inner diameter AI.

Further, the part AA′ of the hollow fiber membrane 43, taken along line 43A-43A′, having the maximum value of the outer diameter AO or the inner diameter AI may have the maximum thickness and the part BB′ of the hollow fiber membrane 43, taken along line 43B-43B′, having the minimum value of the outer diameter AO or the inner diameter AI may have the minimum thickness.

Further, with reference to FIGS. 8 to 10, the outer diameter of the hollow fiber membrane 44 may be changed and the inner diameter of the hollow fiber membrane 44 may be constant. That is, the inner diameter AI of a part AA′ of the hollow fiber membrane 44, taken along line 44A-44A′, and the inner diameter BI of a part BB′ of the hollow fiber membrane 44, taken along line 44B-44B′, may be equal but the outer diameter AO of the part AA′ and the outer diameter BO of the part BB′ of the hollow fiber membrane 44 may be different.

Further, with reference to FIGS. 11 to 13, the inner diameter of the hollow fiber membrane 45 may be changed and the outer diameter of the hollow fiber membrane 45 may be constant. That is, the outer diameter AO of a part AA′ of the hollow fiber membrane 45, taken along line 45A-45A′, and the outer diameter BO of a part BB′ of the hollow fiber membrane 45, taken along line 45B-45B′, may be equal but the inner diameter AI of the part AA′ and the inner diameter BI of the part BB′ of the hollow fiber membrane 45 may be different.

The hollow fiber membranes 43, 44 and 45 may be manufactured through wet spinning using a dual pipe nozzle. In wet spinning using a dual pipe nozzle, a non-solvent is discharged through a core of the nozzle and a polymer dope is discharged from a gap between pipes. By cyclically changing the discharge amount of the non-solvent discharged through the core and the discharge amount of the dope, the hollow fiber membranes 43, 44 and 45 may be manufactured. Particularly, a core discharge speed may be changed within the range of 6.5 g/min to 6.9 g/min and a dope discharge speed may be changed within the range of 3.5 g/min to 4.1 g/min in a cycle of 0.1 seconds to 1 minute.

### DESCRIPTION OF NUMERALS AND MARKS

10: hollow fiber membrane module
1: housing unit
12: circumferential part
121: injection hole
122: discharge hole
12a: end of circumferential part
2: potting unit
4: hollow fiber membrane unit
41, 42, 43, 44: hollow fiber membrane
42A42A′, 43A43A′, 44A44A′, 45A45A′: part AA′
43B43B′, 44B44B′, 45B45B′: part BB′
5: cover
51: gas entrance
AI: inner diameter of part AA′
AO: outer diameter of part AA′
BI: inner diameter of part BB′
BO: outer diameter of part BB′
S: sealing member

### MODE FOR INVENTION

### Test Examples: Manufacture of Humidification Module

### Test Example 1

19,000 hollow fiber membranes formed of polyimide (having an outer diameter which is changed within the range of 850 to 950 μm in a cycle of 20 mm in the length direction and an inner diameter which is changed within the range of 650 to 750 μm in a cycle of 20 mm in the length direction) are disposed within a housing (having a diameter of 202 mm and a length of 400 mm), both ends of the housing are covered with caps for forming potting units, and a composite for potting is injected into spaces between the hollow fiber membranes and a space between the hollow fiber membranes and the housing and then hardened so as to seal the inside of the housing. After the caps for forming potting units are removed from the housing, ends of the hardened composite for potting are cut so that ends of the bundle of the hollow fiber membranes are exposed from the cut ends of the composite for potting, thereby forming potting units (having a diameter of 200 mm and a length of 300 mm). Thereafter, covers are put on both ends of the housing. Thereby, a humidification module is manufactured.

Here, the hollow fiber membranes are manufactured through wet spinning using a dual pipe nozzle. In more detail, the hollow fiber membranes having the mean outer diameter of 900 μm and the mean inner diameter of 700 μm are manufactured by changing a core discharge speed within the range of 6.5 g/min to 6.9 g/min and a dope discharge speed within the range of 3.5 g/min to 4.1 g/min in a cycle of 1 second.

### Test Example 2

19,000 hollow fiber membranes formed of polyimide (having a constant outer diameter of 900 μm and an inner diameter which is changed within the range of 650 to 750 μm in a cycle of 20 mm in the length direction) are disposed within a housing (having a diameter of 202 mm and a length of 400 mm), both ends of the housing are covered with caps for forming potting units, and a composite for potting is injected into spaces between the hollow fiber membranes and a space between the hollow fiber membranes and the housing and then hardened so as to seal the inside of the housing. After the caps for forming potting units are removed from the housing, ends of the hardened composite for potting are cut so that ends of the bundle of the hollow fiber membranes are exposed from the cut ends of the composite for potting, thereby forming potting units (having a diameter of 200 mm and a length of 300 mm). Thereafter, covers are put on both ends of the housing. Thereby, a humidification module is manufactured.

Here, the hollow fiber membranes are manufactured through wet spinning using a dual pipe nozzle. In more detail, the hollow fiber membranes having the mean outer diameter of 900 μm and the mean inner diameter of 700 μm are manufactured by changing a core discharge speed within the range of 6.5 g/min to 6.9 g/min and a dope discharge speed within the range of 3.5 g/min to 4.1 g/min in a cycle of 1 second.

### Test Example 3

19,000 hollow fiber membranes formed of polyimide (having an outer diameter which is changed within the range of 850 to 950 μm in a cycle of 20 mm in the length direction and a constant inner diameter of 700 μm) are disposed within a housing (having a diameter of 202 mm and a length of 400 mm), both ends of the housing are covered with caps for forming potting units, and a composite for potting is injected into spaces between the hollow fiber membranes and a space between the hollow fiber membranes and the housing and then hardened so as to seal the inside of the housing. After the caps for forming potting units are removed from the housing, ends of the hardened composite for potting are cut so that ends of the bundle of the hollow fiber membranes are exposed from the cut ends of the composite for potting, thereby forming potting units (having a diameter of 200 mm and a length of 300 mm). Thereafter, covers are put on both ends of the housing. Thereby, a humidification module is manufactured.

Here, the hollow fiber membranes are manufactured through wet spinning using a dual pipe nozzle. In more detail, the hollow fiber membranes having the mean outer diameter of 900 μm and the mean inner diameter of 700 μm are manufactured by changing a core discharge speed within the range of 6.5 g/min to 6.9 g/min and a dope discharge speed within the range of 3.5 g/min to 4.1 g/min in a cycle of 1 second.

### Comparative Example 1

19,000 hollow fiber membranes formed of polyimide (having an outer diameter of 900 μm and an inner diameter of 700 μm) are disposed within a housing (having a diameter of 202 mm and a length of 400 mm), both ends of the housing are covered with caps for forming potting units, and a composite for potting is injected into spaces between the hollow fiber membranes and a space between the hollow fiber membranes and the housing and then hardened so as to seal the inside of the housing. After the caps for forming potting units are removed from the housing, ends of the hardened composite for potting are cut so that ends of the bundle of the hollow fiber membranes are exposed from the cut ends of the composite for potting, thereby forming potting units (having a diameter of 200 mm and a length of 300 mm). Thereafter, covers are put on both ends of the housing. Thereby, a humidification module is manufactured.

[Experiment: Measurement of Performance of Manufactured Potting Units]

After humid air of 100 g/sec having a temperature of 80° C. and a humidity of 80% is supplied to the outsides of the hollow fiber membranes of the humidification modules, manufactured by the test examples and comparative example, at a pressure of 0.5 bar and dry air having a temperature of 30° C. and a humidity of 30% is supplied to the insides of the hollow fiber membranes, the humidification modules are kept for 30 minutes.

Thereafter, the temperatures, relative humidities, absolute humidities and pressures of the flows of air, supplied to the insides of the hollow fiber membranes, are measured at the discharge holes.

TABLE 1

| | Pressure | | | Absolute |
|---|---|---|---|---|
| | Drop | Temperature | Relative | Humidity |
| | (kPa) | (° C.) | Humidity (%) | (HR, g/kg) |
| Test Example 1 | 12.9 | 66 | 46 | 75.5 |
| Test Example 2 | 12.6 | 67 | 42 | 71.5 |
| Test Example 3 | 11.3 | 67 | 43 | 73.8 |
| Comparative | 11.5 | 66 | 38 | 60.7 |
| Example 1 | | | | |

With reference to Table 1, it may be understood that the humidification modules manufactured by the test examples remarkably increase pressure drop but have greatly improved humidification performance, as compared to the humidification module manufactured by the comparative example.

The humidification modules manufactured by the test examples 1 to 3 employ the hollow fiber membranes having the same mean inner diameter or mean outer diameter, the inner diameters or outer diameters of which are changed in a constant cycle, thus inducing turbulence on the surfaces of the hollow fiber membranes and increasing a coefficient of mass transfer. Consequently, these humidification modules may acquire humidification performance improvement effects which are most important in humidification modules.

Particularly, in the case of the hollow fiber membranes applied to the test example 1, both inner and outer diameters of the hollow fiber membranes are changed in a constant cycle and, thereby, it may be understood that a coefficient of mass transfer is most improved due to turbulent flow effects at the outside and inside of the hollow fiber membranes and the highest humidification performance is acquired.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

### INDUSTRIAL APPLICABILITY

The present invention relates to a hollow fiber membrane and a hollow fiber membrane module including the same, and the hollow fiber membrane is characterized in that any one selected from the group consisting of the inner diameter and the outer diameter the hollow fiber membrane and a combination thereof is changed.

The hollow fiber membrane induces turbulence of a fluid flow at the inside and outside of the hollow fiber membrane and, thus, improves flow uniformity, thereby maximizing performance of the hollow fiber membrane module including the hollow fiber membrane.

The hollow fiber membrane module may be used not only as a humidification module but also as a heat exchange module, a gas separation module or a water treatment module.

1. A hollow fiber membrane configured such that any one selected from the group consisting of the inner diameter of the hollow fiber membrane, the outer diameter of the hollow fiber membrane, and a combination thereof is changed in the length direction.

2. The hollow fiber membrane according to claim 1, wherein change of the any one, selected from the group consisting of the inner diameter of the hollow fiber membrane, the outer diameter of the hollow fiber membrane, and a combination thereof, in the length direction has a cycle.

3. The hollow fiber membrane according to claim 2, wherein change of the any one, selected from the group consisting of the inner diameter of the hollow fiber membrane, the outer diameter of the hollow fiber membrane, and a combination thereof, in the length direction is repeated in a cycle having a length being 2 to 40 times the mean outer diameter of the hollow fiber membrane.

4. The hollow fiber membrane according to claim 1, wherein the inner diameter of the hollow fiber membrane is changed within ±40% of the mean inner diameter of the hollow fiber membrane.

5. The hollow fiber membrane according to claim 1, wherein the outer diameter of the hollow fiber membrane is changed within ±40% of the mean outer diameter of the hollow fiber membrane.

6. The hollow fiber membrane according to claim 1, wherein the outer diameter of the hollow fiber membrane is 0.5 to 1.8 mm.

7. The hollow fiber membrane according to claim 1, wherein the inner diameter of the hollow fiber membrane is 0.2 to 1.5 mm.

8. The hollow fiber membrane according to claim 1, wherein the hollow fiber membrane has the maximum value of the inner diameter at a position having the maximum value of the outer diameter and has the minimum value of the inner diameter at a position having the minimum value of the outer diameter.

9. The hollow fiber membrane according to claim 8, wherein the hollow fiber membrane has the maximum thickness at the position having the maximum value of the outer diameter and has the minimum thickness at the position having the minimum value of the outer diameter.

10. The hollow fiber membrane according to claim 1, wherein the inner diameter of the hollow fiber membrane is changed in the length direction and the outer diameter of the hollow fiber membrane is constant.

11. The hollow fiber membrane according to claim 1, wherein the outer diameter of the hollow fiber membrane is changed in the length direction and the inner diameter of the hollow fiber membrane is constant.

12. A hollow fiber membrane module comprising:
a housing unit; and
a hollow fiber membrane unit installed within the housing unit and including a plurality of hollow fiber membranes,
wherein at least one of the hollow fiber membranes is configured such that any one selected from the group consisting of the inner diameter of the hollow fiber membrane, the outer diameter of the hollow fiber membrane, and a combination thereof is changed in the length direction.

13. The hollow fiber membrane module according to claim 12, wherein both ends of the housing unit are open and an injection hole and a discharge hole are formed on the outer surface of the housing unit.

14. The hollow fiber membrane module according to claim 12, further comprising potting units configured to fix both ends of the hollow fiber membranes to the housing unit and contacting both ends of the housing units so as to be hermetically sealed.

15. The hollow fiber membrane module according to claim 12, further comprising covers combined with both ends of the housing unit and including gas entrances.

16. The hollow fiber membrane module according to claim 12, wherein hollow fiber membrane module is any one selected from the group consisting of a gas separation module, a humidification module and a water treatment module.
